(19) United States
(12) Patent Application Publication
(10) Pub. No.: US 2010/0251611 A1
(43) Pub. Date: Oct. 7, 2010

(54) Horticultural container lining for enhancing contained soil's water absorption

(75) Inventor: David Lee Henson, Northfield, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Think Mint Incorporated, Northfield, MN (US)

(21) Appl. No.: 12/573,597

(22) Filed: Oct. 5, 2009

Related U.S. Application Data
(63) Continuation of application No. 10/922,552, filed on Aug. 20, 2004, now abandoned.
(60) Provisional application No. 60/497,151, filed on Aug. 22, 2003.

(51) Int. Cl. A01G 9/02

(52) U.S. Cl. 47/65.8; 47/66.7

(57) ABSTRACT

A natural fiber lining material 10 for horticultural containers 16 which is placed below soil 14 and will not absorb or release water 30 until soil is saturated with water.

### CROSS-REFERENCE TO RELATED APPLICATIONS

This application claims the benefit of PPA Ser. No. (APPL No.) 60/497,151 filed Aug. 22, 2003 by the present inventor.

### BACKGROUND

This invention relates to horticultural containers, particularly those that allow drainage (wire baskets, plastic, clay, wooden or stone containers with holes).

Horticultural containers have historically been produced to allow drainage of water to avoid root rot and “over watering” related problems. One category of container is open wire baskets lined with Moss or coconut fiber mats to enhance the beauty of the container and hold in the soil. A second category of container is closed plastic or clay containers with drainage holes. Both categories of containers tend to dry out when used by consumers having a detrimental effect on the plants. When the soil is dry and water is applied, the water runs quickly through the soil and out the bottom.

The first category of containers includes open wire baskets lined with coconut coir fiber or moss and are too porous and drain too quickly for the soil to uptake and hold water. These liner materials also and are too porous and drain too quickly for the soil to uptake and hold water. These liner materials also suffer from allowing excessive airflow causing drying. U.S. Pat. Nos. 6,725,599; 5,454,191; 5,363,592; 5,171,390; 5,070,645; 5,018,300; 4,528,774; 3,958,365; 3,818,633; 3,187,463; 2,848,842; 1,912,914 all concern themselves with either limiting the loss of water by reducing porosity or increasing the liners water holding capacity.

The second category of containers are solid plastic or clay with drainage holes and also drain faster than the soil can uptake its maximum amount of water. U.S. Pat. No. 5,860,249 and others have addressed this issue by adding various reservoir systems to contain excess water. Reservoir systems catch excess water to increase the time soil is in contact with water.

### SUMMARY

The invention discussed herein is a natural fiber liner that is laid in a container below soil. The liner initially repels water until the soil on its surface reaches saturation. The liner then absorbs water and upon absorptive saturation releases excess water. The liner's delayed absorption allows the soil in the container time to uptake (or absorb) more water.

The invention described herein and manufactured from natural Kenaf fiber with a binder offers the natural appeal of coconut or moss lined baskets but increases the water held in a 14″ basket by as much as 80% (1.8 times). My liner design is unique in that it maximizes the contained soil's water absorption prior to absorbing water into the liner and ultimately releasing excess water.

In accordance with the present invention, a liner comprises a fibrous mat held together with a binder cut to fit various sized horticultural applications.

My liner invention allows the soil to fully saturate with water before releasing (or draining) excess water. Additionally, my liner assists in the conservation of water through less water flow off. The liner also reduces the need for fertilizers and water dissolved chemical enhancers, as less of these additives are lost in excessive draining.

My basket liner is offered in a convenient sheet form that, when wet, can be applied to complex wire forms and remain in the complex shape. In contrast to embodiments of the present invention, coconut coir fiber is very stiff with a memory and wants to spring back into original sheet form. Moss, when applied to complex shapes, is very labor intensive and messy with a tendency to drop.

### OBJECTS AND ADVANTAGES

Accordingly, besides the objects and advantages of the basket liner described above, several objects and advantages of the present invention include:

(a) to provide a liner sheet material for horticultural containers that limits water drainage until the soil reaches saturation;

(b) to provide a natural fiber liner for hanging wire baskets that enhances soil saturation;

(c) to provide a natural fiber liner that allows limited airflow to roots;

(d) to provide a natural fiber liner that enhances soil hydration while resisting mold or mildew;

(e) to provide a natural fiber liner that absorbs water into the liner material;

(f) to provide a natural fiber liner that conforms to complex wire topiary shapes and holds form;

(g) to provide natural fiber liner material that is soft and capable of being cut with scissors;

(h) to provide a natural fiber liner manufactured from a crop that can be grown throughout the world—Kenaf fiber;

(i) to provide a natural fiber liner manufactured from Kenaf fiber;

(j) to provide a natural fiber liner from Kenaf fiber that has been allowed to ret in the field.

Further objects and advantages are to provide my liner material in precut sizes to fit various size horticultural containers. The liner material will also be sold in rolls for the purpose of custom cuts lengths being offered to fill unusual container sizes and shapes. Still further objects and advantages will become apparent from a consideration of the ensuing description and drawings.

### BRIEF DESCRIPTION OF DRAWINGS

In the drawings, closely related figures have the same number but different alphabetic suffixes.

FIG. 1 shows fibrous strands that when bound together comprise a liner.

FIG. 2 shows a preformed section of liner material when bound together.

FIG. 3A shows a wire horticultural container assembly of plants, soil, liner and wire container.

FIG. 3B shows a solid walled horticultural container assembly of plants, soil, liner and solid container with drainage holes.

FIG. 4A shows a diagram of water flowing through a prior art material.

FIG. 4B shows a diagram of a liner according to an embodiment of the present invention holding water above the liner prior to soil saturation.

FIG. 5A shows water held above liner when soil is holding minimal moisture.

FIG. 5B shows water entering liner material when soil has become saturated with water.

FIG. 5C shows water being released through the liner when the liner and soil have become saturated with water.

FIG. 6 shows the liner conformed to a shape of a wire basket.

FIG. 7 shows channels formed in soil, which create a path for water and impair future hydration without a liner.

FIGS. 8A to 8D show a broad spectrum of horticultural containers that can be used in combination with a liner.

FIG. 9 shows the liner functionality can be applied to “in ground” containers in landscape and garden environments.

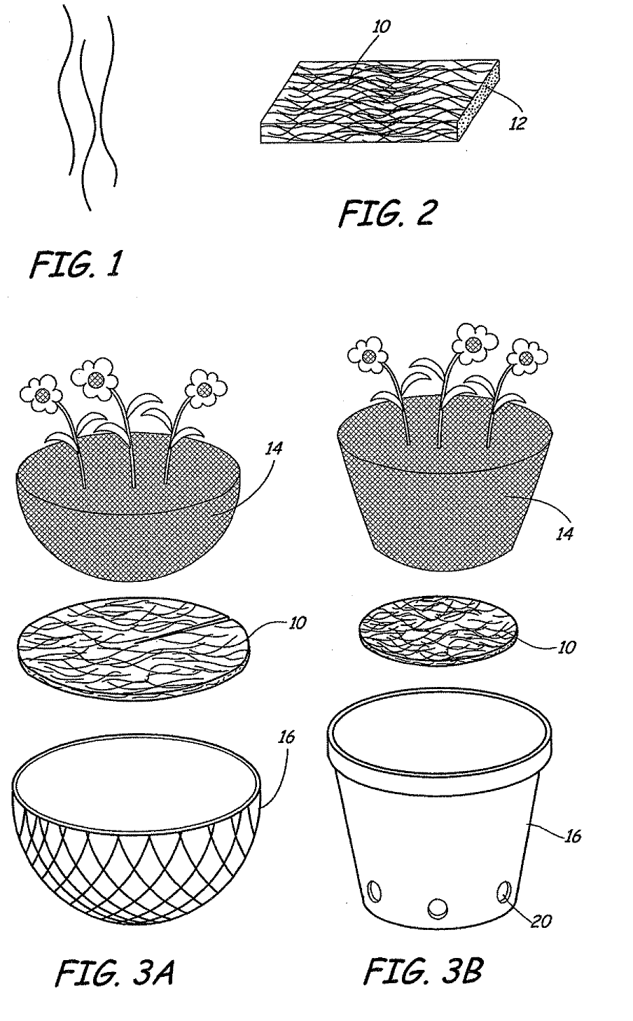

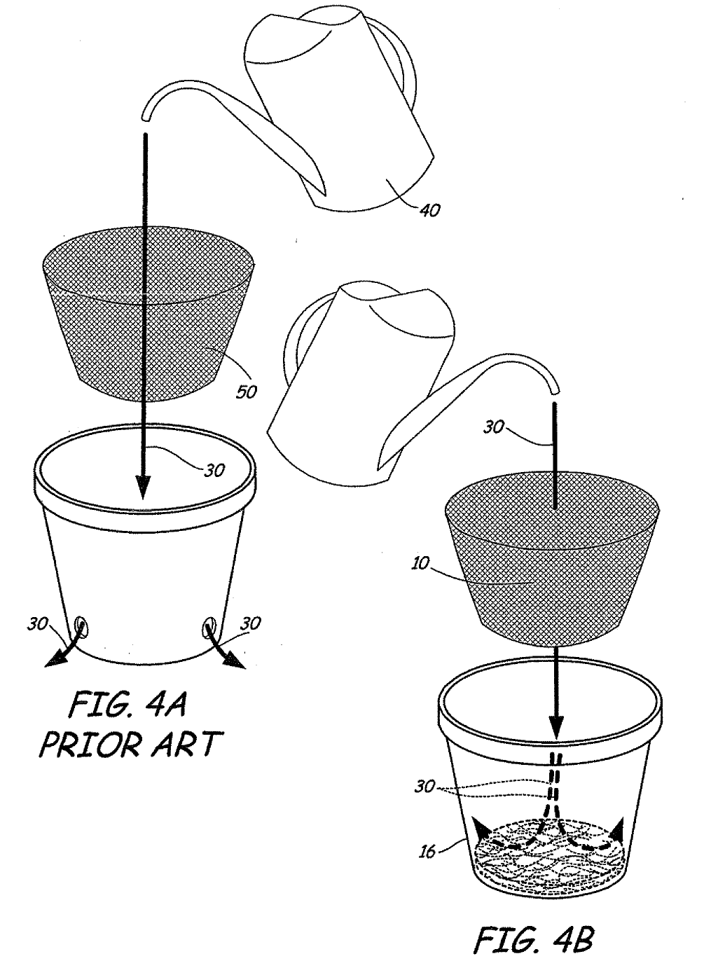

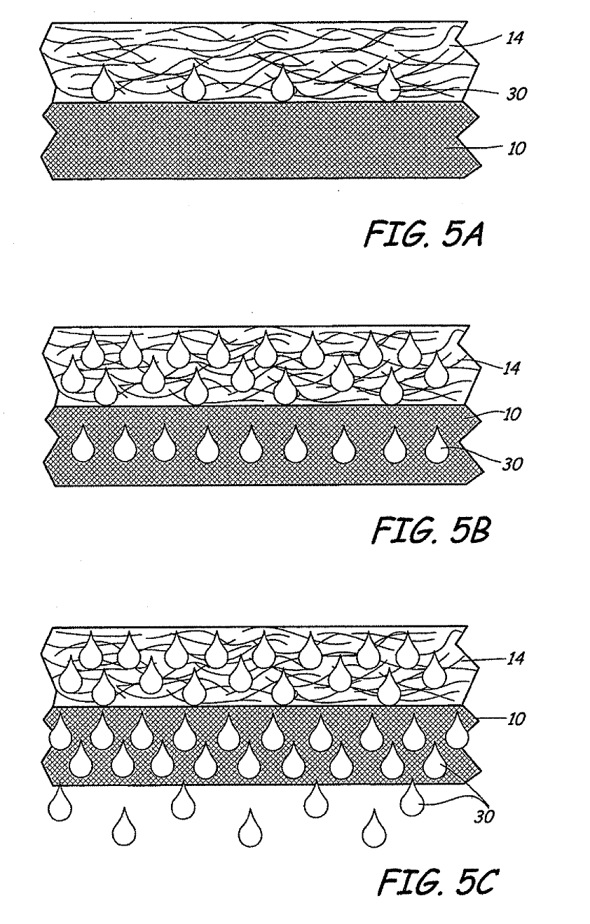

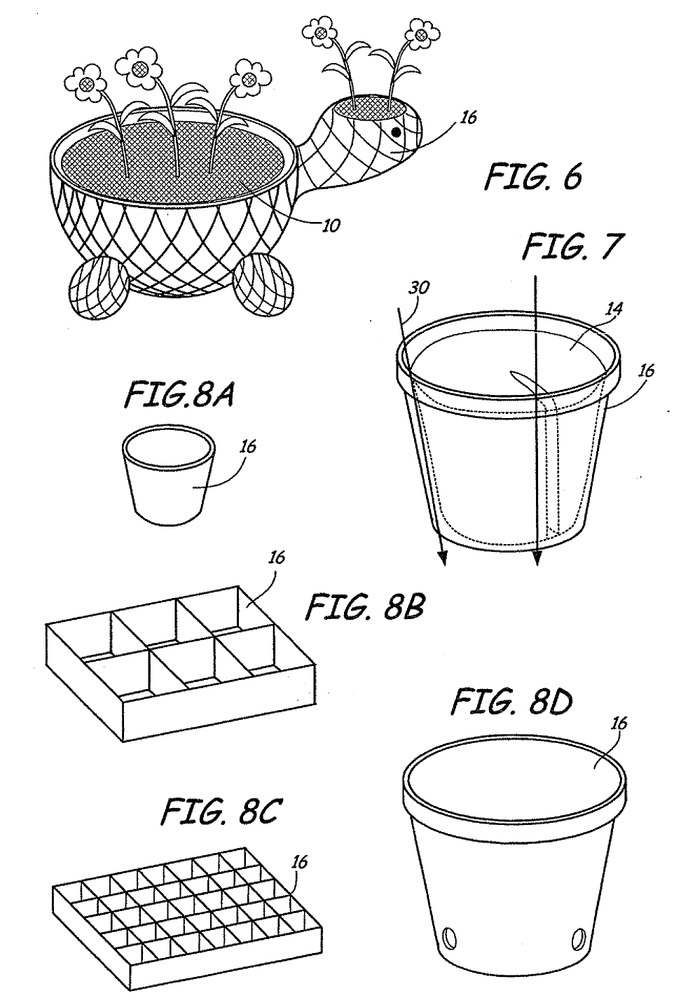

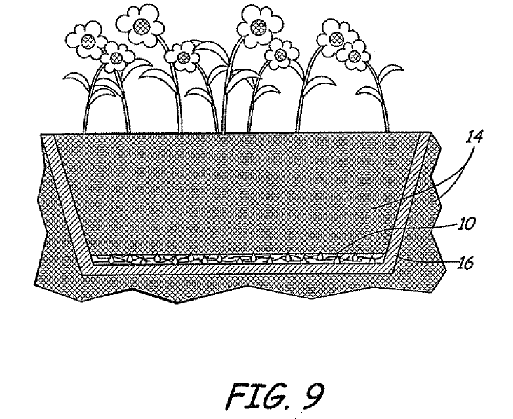

### DRAWINGS REFERENCE NUMERALS

10 formed liner material

12 side profile of material

14 container soil

16 horticultural container

20 drainage holes

30 water

40 watering can

50 inferior lining material

### DETAILED DESCRIPTION

One embodiment of the present invention includes a formed liner material 10 illustrated in FIG. 2 (mat shape) and FIGS. 3A and 3B (liner material precut to different shapes). FIG. 3A illustrates a liner 10 in a circular shape with a slit cut therein so as to fit in a hanging basket. FIG. 3B illustrates a liner 10 in a circular shape placed in a pot. The liner is manufactured from a fibrous material with appropriate absorptive properties such as Kenaf fibers. Kenaf or like fibers are mixed with a chemically stable binding fiber that resists attack by oils, solvents, weak acids or weak alkalis. Copolyolefin Bicomponet fiber (81% polyethylene terephthsalte core) would represent a typical example of binder fiber. The liner 10 can be a mixture 92% Kenaf like fibers with 8% Copolyolefin Bicomponet fibers. A Kenaf plant includes two types of fibers: bast (outer bark) and core (inner). The use of field ret Kenaf fiber is found to offer advantageous coloration and absorptive properties. The ret is formed of bast fibers of a Kenaf plant.

The fibrous mixture is then run through an industrial blanket former where the material is spread out, run through an oven at temperatures appropriate to set the binder fiber and press formed into liner material. A thickness of the processed liners can be ⅛″ to 1″. The density is defined such that droplets of water when applied are not absorbed but when the surface is saturated with water that water is absorbed into the material.

The liner material is then rolled up into 5′ by 50′ sections or as needed sizes to be cut into shapes appropriate for horticultural containers or sliced into bulk size rolls appropriate to custom cutting at garden centers or greenhouse, typically 2′ and 3′ by 50′ rolls.

FIGS. 8A-8D show a sample of the wide range of container that liner material would be cut to fit. For example, the liner can be cut in a circular shape and a rectangular shape.

From the description above the major design advantage of my liner becomes evident: the material is designed to facilitate the soil's saturation with water prior to the liner's saturation with water. Kenaf or Kenaf like fibers are also softer and faster to insert into containers in production environments than coconut coir liners. The wetted Kenaf liner material can hold the form of topiaries when lined as the fiber is not as stiff or hard as the coconut coir fiber. Accordingly, the natural fiber liner of this invention can be used to create healthier and more stable horticultural containers.

My liner material has exceptional advantages in that the liner provides an attractive natural liner material for horticultural containers that limits water drainage until the soil reaches saturation; the liner provides a natural fiber liner for hanging wire baskets that enhances soil saturation; the liner allows limited but not excessive airflow to roots; the natural fiber resists mold or mildew; the liner that absorbs water into the liner material after the soil saturates; the liner conforms to complex wire topiary shapes and holds form; the liner material that is soft and capable of being cut with scissors; the liner manufactured is currently manufactured from a crop that can he grown throughout the world—Kenaf fiber (Coconuts are not an appropriate crop for North America and most of Europe); the liner manufactured from Kenaf fiber; the coloration and performance are enhanced by currently using Kenaf fiber that has been allowed to ret in the field. Although the description above contains many specificities, these should not be construed as limiting the scope of the invention but merely providing illustrations of some of the presently preferred embodiments of this invention. For example, the liner can be used under soil to enhance a myriad of horticultural container shapes and styles like: wire nursery baskets, wreath shapes, etc.

Thus, the scope of the invention should be determined by the appended claims and their legal equivalents, rather than by the examples given.

1-25. (canceled)

26. A horticultural container lining for use under soil, comprising:
a plurality of Kenaf fibers; and
a plurality of binding fibers binding together the plurality of Kenaf fibers to form a liner with a density that initially keeps water from penetrating the liner until the soil above the liner is saturated with water and permitting water to flow through the liner after the soil is saturated.

27. The lining of claim 26 wherein the plurality of Kenaf fibers have been allowed to ret.

28. The lining of claim 26 wherein the mixture includes approximately ninety two percent Kenaf fibers and eight percent binding fibers.

29. The lining of claim 26 wherein the plurality of binding fibers include copolyolefin bicomponent fibers.

30. The lining of claim 26 wherein the plurality of Kenaf fibers and the plurality of binding fibers form a mat.

31. The lining of claim 30 wherein the mat is circular.

32. The lining of claim 31 wherein the mat includes a slit.

33. The lining of claim 30 wherein the mat is rectangular.

34. A combination for containing plant supporting soil, comprising:
a container;
a liner positioned within the container under the soil, the liner including a plurality of Kenaf fibers and a plurality of binding fibers binding together the plurality of Kenaf fibers to form a liner with a density that initially keeps water from penetrating the liner until the soil above the liner is saturated with water and permitting water to flow through the liner after the soil is saturated.

35. The combination of claim 34 wherein plurality of Kenaf fibers have been allowed to ret.

36. The combination of claim 35 wherein the mixture includes approximately ninety two percent Kenaf fibers and eight percent binding fibers.

37. The combination of claim 34 wherein the plurality of binding fibers include copolyolefin bicomponent fibers.

38. The combination of claim 34 wherein the plurality of Kenaf fibers and the plurality of binding fibers form a mat.

39. The combination of claim 38 wherein the mat is circular.

40. The combination of claim 39 wherein the mat includes a slit in the circular shape.

41. The combination of claim 38 wherein the mat is rectangular.

42. The combination of claim 34 wherein the container is a wire basket or a pot.

43. A method of lining a horticultural container having soil to enhance water absorption in the soil, comprising:
providing a plurality of Kenaf fibers; and
providing a plurality of binding fibers that bind the Kenaf fibers together to form a liner with a density initially keeps water from penetrating the liner until the soil above the liner is saturated with water and permitting water to flow through the liner after the soil is saturated.

44. The method of claim 43 wherein the plurality of Kenaf fibers have been allowed to ret.

45. The method of claim 43 wherein the mixture includes approximately ninety two percent Kenaf fibers and eight percent binding fibers.

46. The method of claim 43 wherein the plurality of binding fibers include copolyolefin bicomponent fibers.
